(19) United States
(12) Patent Application Publication
(10) Pub. No.: US 2004/0075775 A1
(43) Pub. Date: Apr. 22, 2004

(54) Device for limiting time of use of electronic equipment

(75) Inventors: Michael M. Maurer JR., Wildwood, MO (US); David I. Kniepkamp, Fairview Heights, IL (US)

Correspondence Address: SENNIGER POWERS LEAVITT AND ROEDEL, ONE METROPOLITAN SQUARE, 16TH FLOOR, ST LOUIS, MO, 63102, US

(73) Assignee: Dr. Michael J. Maurer

(21) Appl. No.: 10/676,217

(22) Filed: Oct. 1, 2003

Related U.S. Application Data
(60) Provisional application No. 60/415,035, filed on Oct. 1, 2002.

(51) Int. Cl. H04N 5/63; H04N 7/16; H04N 7/173

(52) U.S. Cl. 348/730; 725/131; 725/139

(57) ABSTRACT

A device for controlling power to electrically powered equipment. The device includes one or more receptacles for engaging a first power line providing power to the electrically powered equipment. The device includes a second power line for receiving AC power from an AC power source. The device includes one or more switches for selectively interconnecting one of the receptacles to the fist power line. A control circuit controls operation of each of the one or more switches in an allowance mode, non-allowance mode, and in a timed-on mode. In the allowance mode, the control circuit controls the one or more switches so that the electrically powered equipment can only be energized between specified times. . In an non-allowance mode, the control circuit controls the one or more switches so that the electrically powered equipment cannot be energized between specified times. In the timed-on mode, the control circuit controls the one or more switches so that the electrically powered equipment can only be energized for a specific duration of time.

This application claims priority from Provisional Application No. 60/415,035, filed on Oct. 1, 2002.

### TECHNICAL FIELD OF THE INVENTION

The invention relates to a device for limiting the time of use of electrically powered equipment. In particular, the invention relates to a device for controlling power being delivered to electrically powered equipment.

### BACKGROUND OF THE INVENTION

In addition to supervising the selection of television programming or video game content to which children are exposed, the American Academy of Pediatrics recommends limiting the total time children spend watching TV, using video devices, and/or engaging in such passive activity. The ease of access and use of such passive forms of activity too often tilt the balance of children's activity away from those requiring personal involvement, creativity, social interaction, or physical activity. As a result, video entertainment often involves “viewing” and not “doing”. In addition to potential exposure to age inappropriate violence, sexual themes, and language, such passive activity, has been linked to health problems in children. In fact, it is believed that such inactivity has led to more and more children being in poor physical condition, or being clinically overweight at younger and younger ages, and, thus, predisposing them to more health risks.

Accordingly, this invention arose out of the need to provide parents, guardians and/or physicians the ability to limit the amount of time children spend using electronic equipment such as televisions, computers and/or video games. In particular, the invention relates to a device that parents and/or guardians can use to control electrical power to such equipment, and, thus, control the use of such equipment. The device of the invention may also be used to control other electrically powered equipment.

### SUMMARY OF THE INVENTION

The invention meets the above needs by providing a device for efficiently and easily controlling power being supplied to electrically powered equipment.

In one form, the invention comprises a device for controlling power to electrically powered equipment having a power line for supplying power to the equipment. The device comprises one or more receptacles for engaging the power line and selectively supplying power to the equipment. A power line connects to an AC power source. One or more switches are provided, each switch for selectively interconnecting one of the receptacles to the power line. A control circuit controls operation of each of the one or more switches, each switch being controlled by the control circuit to operate in a first mode or a second mode. The first mode controls the switch so that the electrically powered equipment is permitted (i.e., allowed) to be energized between specified times or is restricted (i.e., blocked) from being energized between specified times. Thus the first mode can be described as an allowance mode or a blocking mode. The second mode controls the switch so that the electrically powered equipment is permitted to be energized for a specified duration of time or is restricted from being energized for a specified duration of time.

In another form, the invention comprises a device for controlling power to electrically powered equipment having a power line for supplying power to the equipment. The device includes an input device for entering computer executable instructions. A memory stores the entered executable instructions. The device also includes a clock circuit for generating a clock signal. The device comprises one or more receptacles for engaging the power line and selectively supplying power to the equipment. A power line connects to an AC power source. One or more switches are provided, each switch for selectively interconnecting one of the receptacles to the power line. A control circuit is responsive to the input device, clock signal, and stored executable instructions to controls operation of each of the one or more switches, each switch being controlled by the control circuit to operate in a first mode or a second mode. The first mode controls the switch so that the electrically powered equipment is permitted to be energized between specified times or is restricted from being energized between specified times. The second mode controls the switch so that the electrically powered equipment is permitted to be energized for a specified duration of time or is restricted from being energized for a specified duration of time.

### BRIEF DESCRIPTION OF THE DRAWINGS

FIG. 1 is an isometric view of the control device according to one preferred embodiment of the invention.

FIG. 1A is a rear view of the control device according to one preferred embodiment of the invention.

FIG. 2 is an exemplary block diagram illustrating the components of a control circuit according to one preferred embodiment of the invention. .

FIGS. 2A and 2B are exemplary circuit diagrams that can be used to implement the control circuit illustrated in FIG. 2.

FIG. 3 is an exemplary user interface of the control device.

FIG. 4 is an exemplary flow chart illustrating the user's interaction with a Sign-on menu according to one preferred embodiment of the invention.

FIG. 5 is an exemplary flow chart illustrating the user's interaction with a setup according to one preferred embodiment of the invention.

FIG. 6 is an exemplary flow chart illustrating the user's interaction with an allowance menu according to one preferred embodiment of the invention.

FIG. 7 is an exemplary flow chart illustrating the user's interaction with a Timed-On menu according to one preferred embodiment of the invention.

### DETAILED DESCRIPTION OF PREFERRED EMBODIMENTS

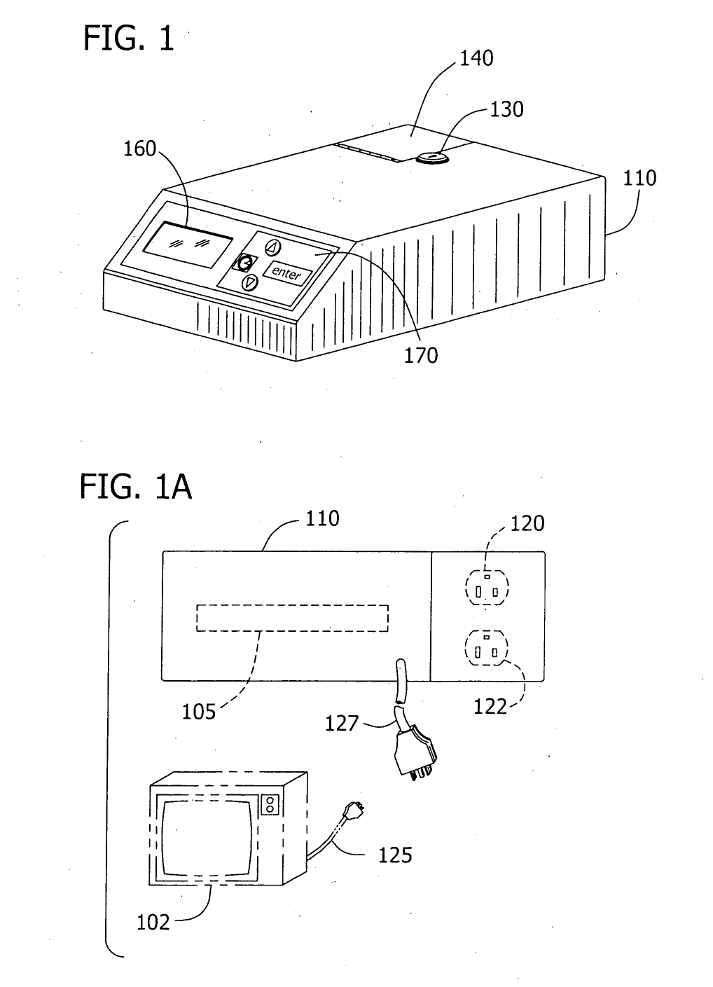

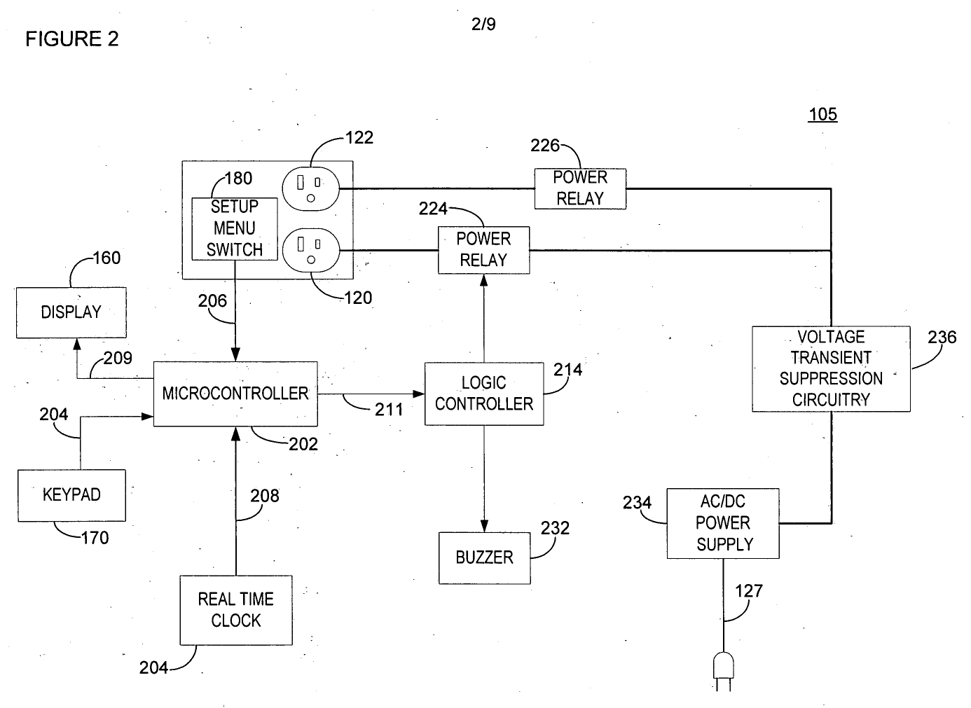

Referring first to FIGS. 1 and 1A, a block diagram illustrates a control device 100 for controlling electrical power being supplied to electrically powered equipment such as a television, a video game and/or a personal computer according to one preferred embodiment of the present invention.

A housing 110 encloses and protects a control circuit 105 of the device 100. In one preferred embodiment, the housing 110 is constructed from a durable material such as a high impact plastic.

Receptacles 120, 122 are configured to engage a plug end of a first power line 125 supplying power to the electrically powered equipment. In one preferred embodiment, each of the receptacles 120, 122 are an EN 6030 inlet connector rated at 120 Volts Alternating Current (VAC) and Underwriters Laboratories (UL) and Canadian Standards Associations (CSA) listed. In other words, each of receptacles 120, 122 is configured to accept standard two-wire and three-wire (grounded) AC power cords (i.e., power line 125) such as commonly used in North America.

A second power line 127 supplies electrical power to the control device 100, and plugs into a power source such as a 120 VAC standard wall outlet. Receptacles 120, 122 are electrically connected to the second power line 127 via the control circuit 105, and are switchably controlled by the control circuit 105 to provide AC power to the electrically powered equipment via the engaged first power line 125.

A key lock 130 allows a user to control access to receptacles 120, 122 via a lockable access panel 140. More specifically, the key lock 130 allows a user to secure a connection between the first power line 125 and one of the receptacles 120, 122. For example, if the key lock 130 is in an “unlocked” position, the access panel 140 can be opened to provide access to the receptacle 120 such that the user can connect or disconnect the first power line 125 from either of the receptacles 120, 122. Alternatively, if the key lock 130 is in a “locked” position, the access panel 140 cannot be opened, and an existing connection between the first power line 125 and either of the receptacles 120, 122 is secured from being disconnected.

A display 160 displays time, date, and menu information. In one embodiment, the visual display 114 is a liquid crystal display (LCD).

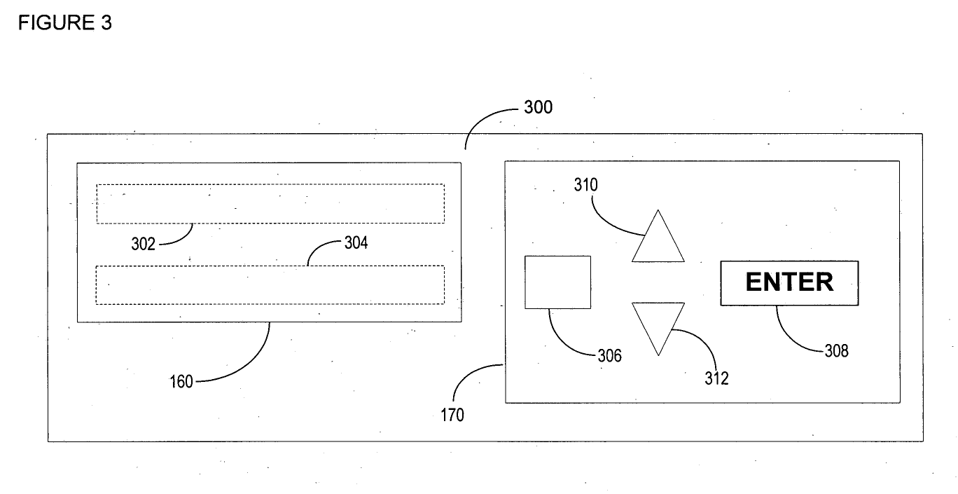

As explained in more detail below in reference to FIG. 3, a keypad 170 allows the user to scroll through and view various menus on the display 160, and allows the user to select, enter, and/or program information required to operate the control device 100. In one preferred embodiment, the keypad 170 includes a three key switch matrix constructed into a graphical overlay, and is electrically connected to the control circuit 105.

A setup menu switch 180 is used to enter a setup menu without entering an authorization code (e.g., password). For example, if the user cannot remember, or does not know, the password required to access the setup menu, the user can gain direct access to the setup menu by toggling or depressing the setup menu switch 180. In one embodiment, the setup menu switch 180 is a momentary mechanical push button switch, and is accessible via the lockable access panel along with AC power receptacles.

In operation, the control device 100 controls operation of the electrically powered equipment according to a first mode or a second mode of operation. The first mode, or allowance mode, corresponds to a mode of operation in which receptacles 120, 122 are only allowed to supply electrical power between specified times. For example, when operating in the allowance mode, receptacle 120 may only supply electrical power between 6:00 PM and 7:00 PM, Monday thru Friday. In contrast, the second mode, or timed-on mode, corresponds to a mode of operation in which receptacles 120, 122 are only allowed to supply electrical power for a specific duration of time. For instance, when operating in the Timed-On mode, receptacle 120 may supply electrical power for a total of 60 minutes.

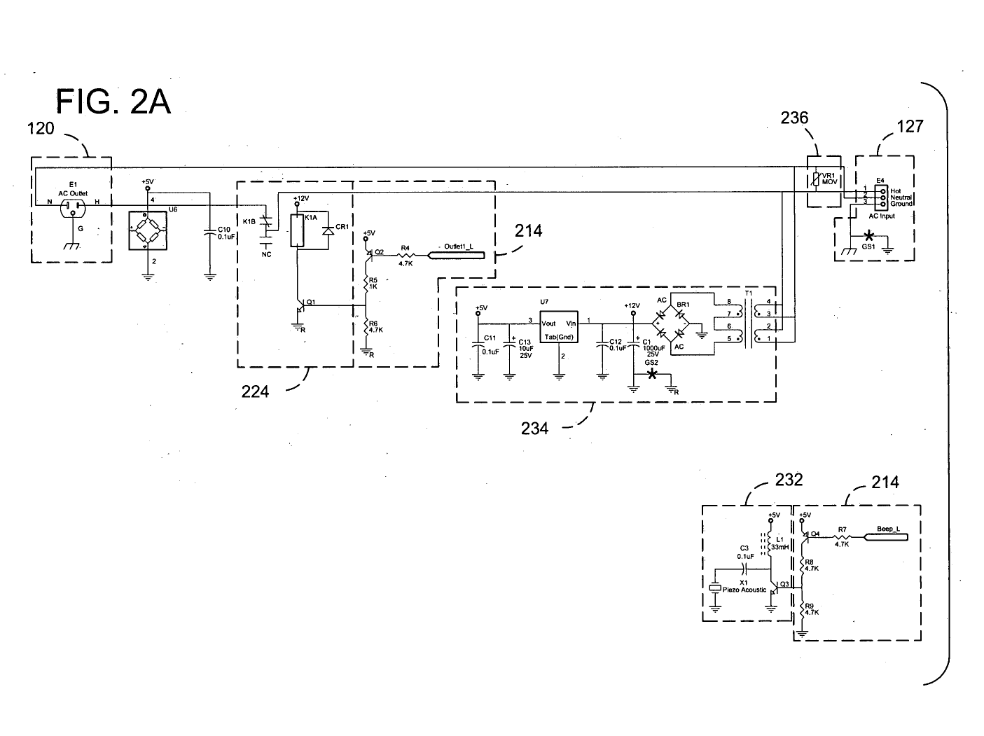

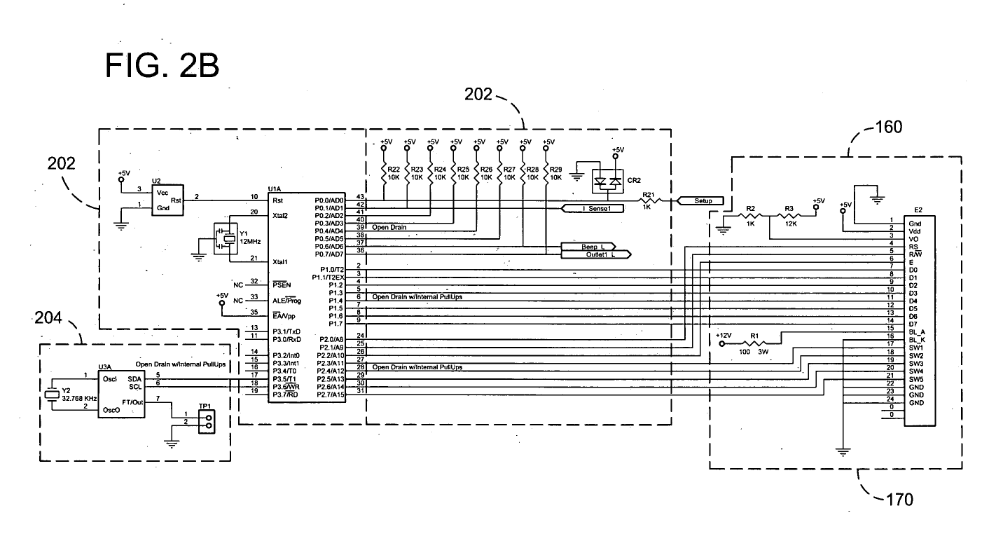

Referring now to FIG. 2, a block diagram illustrates components of the control circuit 105 according to one preferred embodiment of the invention. A microcontroller 202 receives digital input signals 204, 206, and 208 from the keypad 170, the setup menu switch 180, and a real time clock 210, respectively. The microcontroller 202 then executes an algorithm that interprets and converts the received digital signals 204, 206, and 208 into one or more digital output signals. In a preferred embodiment, the microcontroller 202 is a Philips Microcontroller such as model number P87C51RB+1A available from Royal Philips Electronics. The microcontroller 202 includes an onboard nonvolatile memory used for program code (e.g., algorithm) storage, a read/write nonvolatile memory used for data storage of the password, specified times (e.g., allowance mode), and specified durations (e.g., timed-on mode), and a random access memory (RAM) for normal program operation. Output signals 209, 211 are generated by microcontroller 202, and are provided to the display 160 and a logic controller 214, respectively. The output signal 209 provided to the LCD display 160 includes binary data, and is used to generate numeric and textual characters which are used to display time, date, and menu information to the user.

The real time clock 210 generates the clock signal 208, which is provided to the microcontroller 202. The clock signal is used by the microcontroller 202 to determine the current time of day, and current day of week. In one embodiment, the clock 202 is an integrated circuit (IC) such as model number MC7805CT available from STMicroelectronics®.

The logic controller 214 receives the digital output signal 211, or “inhibit signal,” from the microcontroller, and generates power control signals 220, 222. The logic controller 214 performs several hardware functions, and can be implemented through the use of a single programmable logic device such as an integrated circuit (IC) chip part or through the use of discrete logic components. In one embodiment, the functions required of the logic controller 214 include the reception and processing of the received digital output signal 211 the activation of one or more power relays, and the activation of an alarm when appropriate. For example, the logic controller 214 is responsive to the keypad 170 and microcontroller 202 to generate an alarm signal that can be used to activate an alarm or buzzer. In one embodiment, the logic controller 214 drives a buzzer 232 when a violation has been detected by the microcontroller 202 such as an invalid entry via the keypad 170. In another embodiment, the microcontroller is responsive to the clock signal and to activate the buzzer at a preset period (e.g., one minute) before the power to the equipment terminates. The buzzer 232 can be a small DC powered component that produces an audible sound to indicate an alarm condition. For example, a short audible beep is sounded via buzzer 232 when an invalid entry or key press is made. A long audible beep is sounded via buzzer 230 when an invalid password is entered to discourage attempts at trying to guess the password. In another embodiment, if a key press is not detected within a five-minute time interval while within a particular menu, the menu is automatically exited, and normal operation is resumed.

Powers relays 224, 226 control or inhibit the power being supplied from the second power line 127 to receptacles 120, 122, and, thus, the electrically powered equipment. More specifically, power relays 224, 226 are AC power switches that are responsive to output control signals 220, 222 to create either an open circuit condition or a closed circuit condition. For example, if the output signal 220 of the logic controller 214 has a magnitude of five (5) volts (i.e., logical 1), the power relay closes creating a closed circuit condition, and the AC power from the second power line 127 provided to receptacles 120, 122. As a result, any electrically powered equipment connected to receptacles 120, 122 will operate. As another example, if the output signal 220 of the logic controller 214 has a magnitude of zero (0) volts (i.e., logical 0), the power relay opens creating an open circuit condition, and the AC power from second power line 127 to receptacles 120, 122 is inhibited from reaching receptacles 120, 122. As a result, any electrically powered equipment connected to receptacles 120, 122 cannot operate. In this embodiment, power relays 224, 226 operate independently, and switchably control receptacles 120, 122, respectively. For example, the logic controller 214 may provide a control signal to power relay 224 such that it closes to allow any electrically powered equipment connected to the receptacle 120 to operate, and may provide a control signal to power relay 226 such that it opens to prevent any electrically powered equipment connected to receptacle 122 from operating. The output signal 211 is referred to herein as an “inhibit signal,” because it determines whether the logic controller 214 provides output signals 220, 222 to power relays 224, 226 that inhibit receptacles 120, 122 from providing power to any connected electrically powered equipment.

A DC power supply 234 converts the normal 120 VAC power being supplied to the control device 100 via the second power line 127 into a regulated DC output(s), which is then distributed to components of the control circuit 105. The DC power supply 234 also provides for the monitoring of a low voltage condition on the microcontroller's power, and controls its reset line during a low voltage condition to prevent spurious operations.

A voltage transient suppression circuit 236 provides over voltage surge protection for the control device 100, and any attached units (i.e., electrical equipment). The voltage transient suppression circuit 236 is intended to provide for protection from typical voltage spikes found on AC power lines in a residential or office building setting. In a preferred embodiment, the control device 100 provides an adequate energy dissipation rating to protect the control device 100 and two connected units, while still maintaining the device's overall cost objectives.

FIGS. 2A and 2B illustrate exemplary circuit diagrams used to implement the control circuit according to the embodiment illustrated in FIG. 2.

Referring now to FIG. 3, a user interface 300 of the control device 100 is shown. In this case, the user interface 300 includes the display 160 and the keypad 170. The user interface 300 allows the user to access and view menus including a sign-on menu, a setup menu, and operational menus that correspond to an allowance mode and a timed-on mode. In order to access the setup menu and operational menus, a valid password must be entered via keypad 170. However, as explained above, the setup menu can also be accessed via the setup menu switch 180. Thus, the setup menu switch 180 also provides a means for the user to interface with the control device 100. Formats for the various menus, along with the associated options for each specific menu field, are shown in Tables 1-4 of the Appendix A.

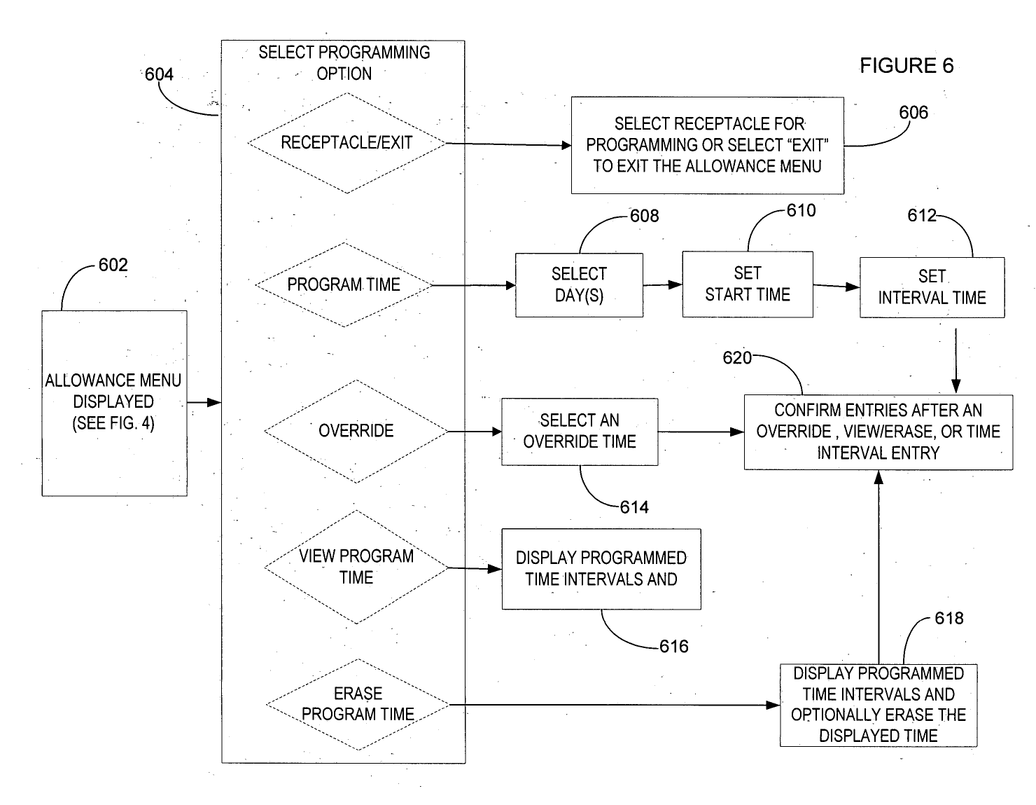

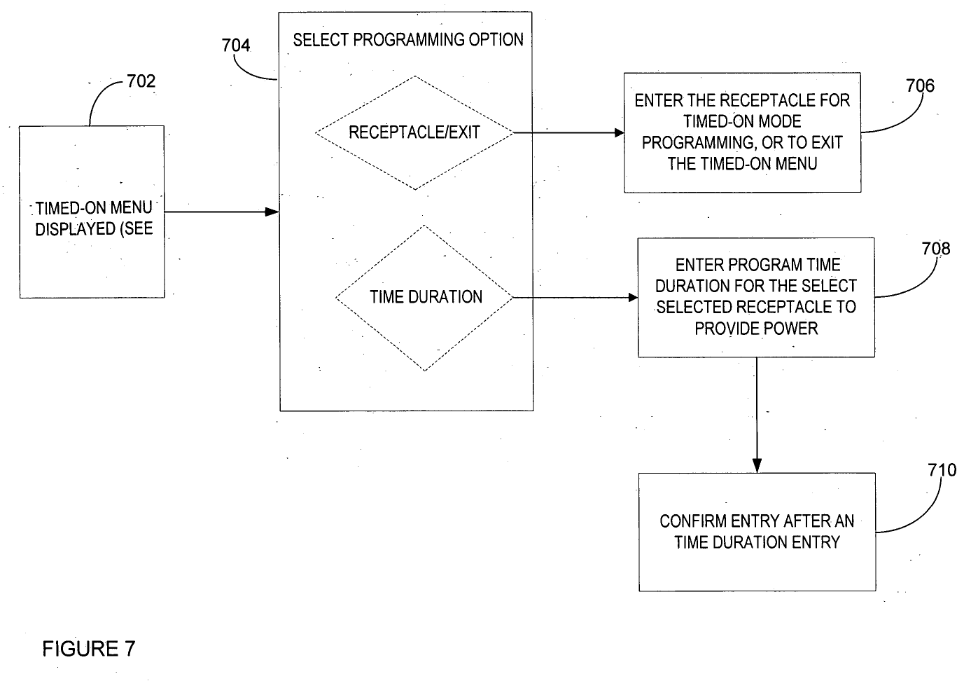

The display 160 is preferably of a Liquid Crystal Diode (LCD) type construction, and is configured to provide two lines of display, as indicated by reference characters 302, 304, and wherein each line of display is capable of displaying at least 16 characters. The keypad 170 is an input device that includes an enter key 308, an up arrow key “↑” 310, and a down arrow key “⇓” 312. The select key 302 is used to scroll through the various menus being shown on the first line 302 of the display. Arrow keys 310, 312 are used for scrolling upward or downward, respectively, through various menu fields being displayed on the second line of the display 160. The extended viewing key 306 is used to extend or override programmed times whether the control device is operating in the allowance, non-allowance (i.e., blocking mode), or timed on mode for a one-time interval such 15 minutes (See FIG. 6 and FIG. 7 below). Enter key 308 is used to select a specific menu being displayed on the first line 302 of the display 160, and/or is used to select the menu option being displayed on the second line 304 of the display 160.

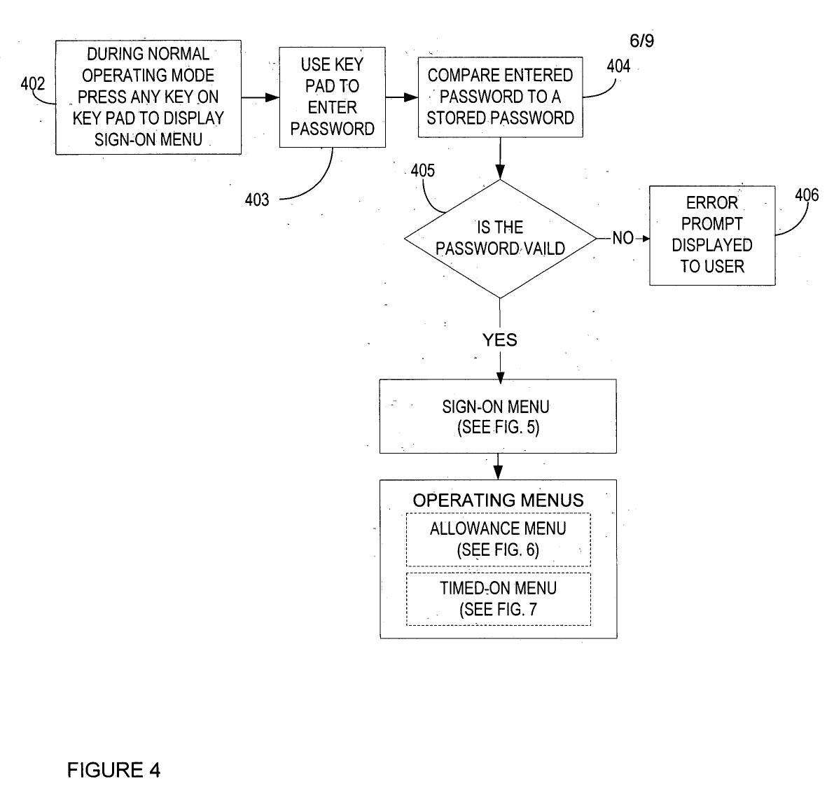

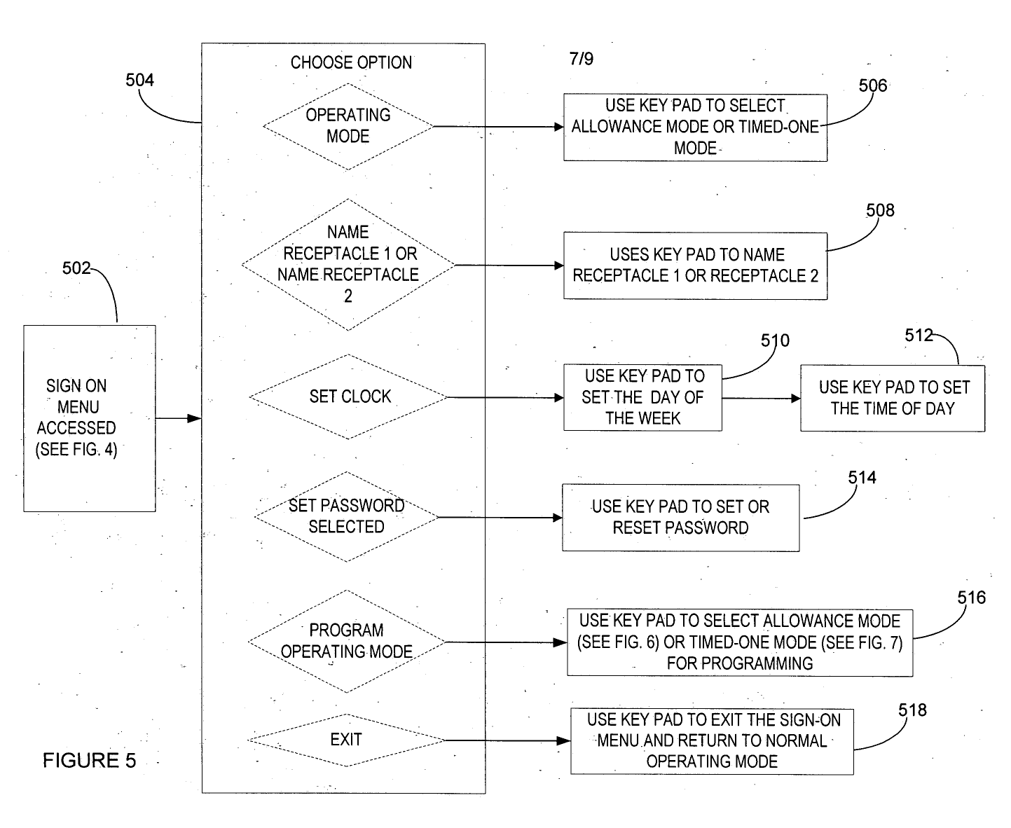

Referring now to FIG. 4, a flow chart illustrates a sign on process according to one preferred embodiment of the invention. At 402, while in normal operating mode (See Appendix A: Table 1), the user uses the keypad 160 to display the sign-on menu, and uses the keypad 160 to enter a password to access the setup and/or operation menus at 403. For instance, while in the normal operating mode the user can presses any key (i.e. enter key or arrow keys) to display the sign-on menu on the first line 302 of the display 160, and then depresses the enter key 308 to enter the sign-on menu. The user uses the arrow keys 310, 312 to scroll through numbers 0-9 until the correct number is displayed for the first digit of the password on the second line 304 of the display 160. The user then depresses enter key 308 to accept the number being displayed as the first digit of the password, and move to a next digit of the password. This process is repeated until a number has been entered for each digit of the password. In other words, if the password contains four digits, this process is repeated four times. At 404, the entered password is compared to a password stored in a memory (e.g., microcontroller 202). If the password is determined to be invalid at 405, an error prompt is displayed via display 160 at 406. On the other hand, if the password is determined valid at 405, the user uses the keypad 170 to gain access to the sign-on menu (see FIG. 5) at 408, and/or access operating menus (e.g., allowance menu (see FIG. 6) or a Timed-On menu (see FIG. 7)) at 410. Table 2 in the Appendix A shows the format of information being displayed via the first line 302 and second line 304 of the display 106 during the sign-on process according to one preferred embodiment.

Referring now to FIG. 5, a flow chart illustrates the user's interaction with the sign on menu to choose a particular option such as set the operating mode (e.g., allowance or timed-on), set or reset the password, name receptacles (e.g., receptacle #1=TV), set clock time (e.g., current day of week and current time of day), and program operating modes. At 504, the user uses the arrow keys 310, 312 to scroll through and display the desired setup option, and uses enter key 308 to select the particular setup option being displayed. If the set operating mode option is selected at 504, the user uses the arrow keys 310, 312 to scroll through the list of operating modes until the desired operating mode is displayed, and then depresses the enter key 308 to select the displayed operating mode as the operating mode of the control device 100 at 506. In this case, operating modes include an allowance mode and a timed-on mode. As described above, the allowance mode corresponds to a mode of operation in which receptacles 120, 122 are allowed to supply electrical power between specified times, and the timed-on mode corresponds to a mode of operation in which receptacles 120, 122 are allowed to supply electrical power for a specific duration of time. Table 3 in the Appendix A shows the format of information being displayed via the first line 302 and second line 304 of the display 106 for the various operations available via the setup menu according to one preferred embodiment.

If the Name Receptacle1 option is selected at 504, the user uses the arrow keys 310, 312 to scroll through a list of receptacle names until a desired receptacle name is displayed, and then depresses the enter key 308 to select the displayed receptacle name as the name for Receptacle1 (e.g., receptacle 120) at 508. An error prompt is presented to the user if the selected name has already been assigned to the other receptacle. Alternatively, if Name Receptacle2 is selected at 502, the user uses the arrow keys 310, 312 to scroll through the list of receptacle names until a desired receptacle name is displayed, and then depresses the enter key 308 to select the displayed receptacle name as the name for Receptacle2 (e.g., receptacle 122) at 508. An error prompt is presented to the user if the selected name has already been assigned to the other receptacle. In one preferred embodiment, an “Open” choice is available as a setting to indicate that a particular receptacle is not in use.

If the set clock option is selected at 504, the user uses the arrow keys 310, 312 to scroll through days of the week (e.g., Sunday-Saturday) until the desired day is displayed, and then depresses the enter key 308 to select the displayed day as the current day of the week at 510. At 512, the user uses arrow keys 310, 312 scroll through hours (e.g., 1-12) and minutes (e.g., 0-59) until the desired time with appropriate AM and PM indication is displayed, and then depress the enter key 308 to set displayed time as the current time of day.

If the set or new password option is selected at 504, for each digit of the password (e.g., four digits), the user uses the arrow keys 310, 312 to scroll through numbers or characters values (e.g., 0 to 9) until the desired value is displayed, and then uses the enter key 308 to select the displayed value for that particular digit of the password at 514.

If the program operating modes option is selected at 504, the user uses the arrow keys 310, 312 to scroll through the list of operating menus (i.e., allowance menu and timed-on menu until) the desired operating menu is displayed, and then depresses the enter key 308 to select the displayed operating mode as the operating mode for which to program at 516. Thereafter, the selected operating menu is displayed to the user.

If the Exit option is selected at 504, the user depresses enter key 308 to exit the sign-on menu and return to the normal operating mode.

Referring now to FIG. 6, a flow chart illustrates the user's interaction with the allowance menu according to one preferred embodiment of the invention. The allowance menu allows the user to program a first mode of operation for each of the receptacles 120, 122. The first mode includes an allowance mode that corresponds to specified times between which electrically powered equipment connected to a particular receptacle of the device 100 can be energized, and a non-allowance mode that corresponds to specified times in which electrically powered equipment connected to a particular receptacle is restricted or prohibited from being energized. The allowance menu provides the user with programming options such as a receptacle/exit option, an override option, a program time option, a view program time option, and an erase program time option. At 602, the allowance menu is displayed to the user, and the user is allowed to choose from various programming options At 604, the user uses arrow keys 310, 312 to display the desired programming option on the second line 304 of the display 160, and depresses enter key 308 to select the option being displayed. Table 4 in the Appendix A shows the format of information being displayed via the first line 302 and second line 304 of the display 106 for the various programming options available via the allowance menu to one preferred embodiment.

The Receptacle/Exit option allows the user to select the particular receptacle program, or allows the user to exit the timed-on menu. If the Receptacle/Exit option is selected at 604, the user uses arrow keys 310, 312 to display the particular receptacle for which to program a time interval, and uses the enter key 308 to select the displayed receptacle (e.g., receptacle1 or receptacle2) for programming an allowance mode, and/or a non-allowance mode of operation at 606. Optionally, the user uses arrow keys 310, 312 to display an “Exit” option on the second line 304 of the display 160, and depresses the enter key 308 to exit from the allowance menu at 606. As described above, the receptacles are assigned names via the setup menu, which aids the user in distinguishing between receptacles during programming

The Program Time option allows the user to program the specified times between which a particular receptacle is allowed to supply electrical power. If the program time interval option is selected at 604, the user uses the arrow keys 310, 312 to scroll through days of the week until the desired day or group of desired days are displayed (e.g., SUN-THU, MON-FRIDAY, SAT-SUN, EVERYDAY, SUN, MON, TUE, WED, THU, FRI, OR SAT) and depresses the enter key 308 to select the displayed day or days for programming a time interval at 608. At the 610, the user uses the arrow keys 310, 312 to scroll through hours (e.g., 1-12) and minutes (e.g., 0-59) until the desired start time with the appropriate AM and PM designation is displayed, and then depresses the enter key 308 to set the displayed time as the start time for the selected day. At 612, the user uses the arrow keys 310, 312 to display an interval length in minutes, and uses the enter key to set the displayed interval as the interval length for the selected receptacle. For example, depressing the up arrow increases the time interval displayed, and depressing the down arrow decreases the time interval displayed. Thereafter, the selected receptacle supplies power to electrically powered equipment beginning at the set start time for the selected day for the set interval length. For example, to allow the selected receptacle to supply power between 6:00 PM and 7:00 PM on Monday, the user uses the keypad 170 to display and enter Monday, display and enter 6:00 PM, and to display and enter a 60-minute time interval. In one embodiment, the user can program a time interval for one day or several days of the week. Notably, the non-allowance mode begins at a time that corresponds to the end of the set time interval of the allowance mode and ends at the next set start time of the allowance mode.

The Override option allows the user to override programmed time intervals such that the selected receptacle can operate (i.e., supply power) outside of the programmed time interval. If the override option is selected at 604, the user uses the arrow keys 310, 312 to scroll through a list of override time (e.g., 5 minutes, 10 minutes, 20 minutes) until a desired override time is displayed, and then depresses the enter key 308 to activate the displayed override time at 614. In alternate embodiment (not shown), the user uses the arrow keys 310, 312 to scroll through a list of override options such as Stay On, Stay Off, All Day, All week, Restore, and No Change, then depresses the enter key 308 to activate the displayed override option.

The View program time option allows the user to view the currently programmed time interval or to erase the currently programmed time interval. If the View program time option is selected at 604, the user uses the arrow keys 310, 312 to view previously programmed time intervals for the selected receptacle at 616. If the Erase program time option is selected at 604, the user uses the arrow keys 310, 312 to display previously programmed time intervals for the selected receptacle, and the user depresses enter key 308 while a particular time interval is displayed, and a prompt (↑=yes and ⇓=no) is displayed at 618. By pressing the up arrow 310, the user can erase the particular time interval being displayed. If the user does not want to erase the particular time interval being displayed, the user presses the down arrow 312.

After an Override time, a View program time, Erase program times, or Program Time Interval entry has been completed, the display prompts the user to either confirm the choice being displayed by pressing the up arrow key 310, or to cancel the change by pressing the down arrow key 312 at 620.

Referring now to FIG. 7, a flow chart illustrates the user's interaction with the Timed-On menu according to one preferred embodiment of the invention. The Timed-On menu allows the user to program a second mode of operation for each of the receptacles 120, 122. The second mode of operation includes a Timed-On mode that corresponds to a duration of time in the electrically powered equipment connected to a particular receptacle can be energized, and a Timed-Off mode that corresponds to a time duration in which electrically powered equipment connected to a particular receptacle cannot be energized. The Timed-On menu provides the user with programming options such as a receptacle/exit option and a program time duration option. At 702, the Timed-On menu is displayed to the user, and the user is allowed to choose from various programming options. At 704, the user uses arrow keys 310, 312 to display the desired programming option on the second line 304 of the display 160, and uses the enter key 308 to select the particular programming option being displayed. Table 5 in the Appendix A shows the format of information being displayed via the first line 302 and second line 304 of the display 106 for the timed-on menu according to one preferred embodiment.

The Receptacle/Exit option allows the user to select the particular receptacle to program, or allows the user to Exit the timed-on menu. If the Receptacle/Exit option is selected at 704, the user uses arrow keys 310, 312 to display the name of the particular receptacle for which to program a time-on mode, and depresses the enter key 308 to select the displayed receptacle for programming the Timed-on mode at 706. Optionally, the user uses keys 310, 312 to display an “Exit” option, and depresses the enter key 308 to exit the Timed-on menu.

The timed-on option allows the user to program a specified amount of time each of the receptacles 120, 122 is allowed to supply electrical power from the time the Timed-on mode is activated. Notably, the Timed-Off mode begins at the end of the specified amount of time the receptacles 120, 122 are allowed to supply electrical power. If the Timed-on option is selected at 704, the user uses the arrow keys 310, 312 to display a desired amount of time, and depresses the enter key 308 to select the displayed time as the amount of time the receptacle is allowed to supply electrical power at 708. In one embodiment, time durations displayed to user are in fifteen-minute increments.

After Timed-on entry has been completed, the display prompts the user to either confirm the choice being displayed by pressing the up arrow key 310, or to cancel the change by pressing the down arrow key 312 at 710.

Appendix B illustrates the menu structure according to alternate embodiment of the invention.

As various changes could be made in the above products and methods without departing from the scope of the invention, it is intended that all matter contained in the above description and shown in the accompanying drawings shall be interpreted as illustrative and not in a limiting sense.

TABLE 1
NORMAL OPERATING DISPLAY

| DESCRIPTION | DISPLAY | | OPTIONS | COMMENTS |
|---|---|---|---|---|
| 1. Normal | Line 1 | DAY | | Day of week |
| Display | | XX:XX YY | | and Time of |
| | | | | day in AM or |
| | | | | PM |
| | Line 2 | Press Any Key | Pressing | XX:XX hours |
| | | -or- | any key | and minutes |
| | | XX:XX | goes to | remaining |
| | | | Sign on | |
| | | | menus | |
| | | | (See Table | |
| | | | 2). | |

TABLE 2
SIGN-ON PROCESS

| DESCRIPTION | DISPLAY | | OPTIONS | COMMENTS |
|---|---|---|---|---|
| 2. Password Entry | Line 1 | Enter Password | | |
| | Line 2 | Password | Arrows | Enter accepts |
| | | X***↑ ↓ | scroll X | 1st digit and |
| | | | 0 thru 9 | goes to 3 |
| 3. | Line 1 | Enter Password | | |
| | Line 2 | Password | Arrows | Enter accepts |
| | | *X**↑ ↓ | scroll X | 2nd digit and |
| | | | 0 thru 9 | goes to 4 |
| 4. | Line 1 | Enter Password | | |
| | Line 2 | Password | Arrows | Enter accepts |
| | | **X* ↑ ↓ | scroll X | 3rd digit and |
| | | | 0 thru 9 | goes to 5 |
| 5. | Line 1 | Enter Password | | |
| | Line 2 | Password | Arrows | Enter accepts |
| | | ***X ↑ ↓ | scroll X | all digits and |
| | | | 0 thru 9 | goes to 6 or 7 |
| 6. Invalid | Line 1 | Invalid | | Appears if |
| Password Entry | | Password | | invalid |
| | | | | password |
| | | | | entered |
| | Line 2 | Press any Key | | Go to 1 (i.e. |
| | | | | Normal |
| | | | | Display) |
| 7. Menu Selection | Line 1 | Choose Action | Press | See Table 4 |
| | | | Enter to | or 5 |
| | | | display | |
| | | | Allowance | |
| | | | or Timed- | |
| | | | On Menu | |
| | Line 2 | Change Times | Press | See Table 3 |
| | | ↑ ↓ | arrows to | |
| | | | access Set | |
| | | | Up Menu | |
| | | | Options | |

TABLE 3
SIGN-ON MENU

| DESCRIPTION | DISPLAY | | OPTIONS | COMMENTS |
|---|---|---|---|---|
| 8. Change or | Line 1 | Choose Action | | |
| select | Line 2 | Change Mode | Arrows | Enter goes to 9 |
| operating | | ↑ ↓ | display | |
| mode | | | other | |
| | | | Set-up | |
| | | | operations | |
| 9. | Line 1 | New Mode | | |
| | Line 2 | AAAAAAA | Arrows | Enter goes to |
| | | ↑ ↓ | scroll thru | menu for |
| | | | A's to | displayed mode |
| | | | display | (i.e., Tables 3 |
| | | | Allowance | or 4) |
| | | | or Timed | |
| | | | ON | |
| | | | Modes | |
| 10. Set Password | Line 1 | Choose Action | | |
| | Line 2 | New Password | Arrows | Enter goes to |
| | | ↑ ↓ | display | 11 |
| | | | other | |
| | | | Set-up | |
| | | | operations | |
| 11. | Line 1 | New Password | | |
| | Line 2 | Password | Arrows | Enter accepts |
| | | X *** ↑ ↓ | scroll X | 1st digit and |
| | | | 0 thru 9 | goes to 12 |
| 12. | Line 1 | New Password | | |
| | Line 2 | Password | Arrows | Enter accepts |
| | | *X** ↑ ↓ | scroll X | 2nd digit and |
| | | | 0 thru 9 | goes to 13 |
| 13. | Line 1 | New Password | | |
| | Line 2 | Password | Arrows | Enter accepts |
| | | **X* ↑ ↓ ** | scroll X | 3rd digit and |
| | | | 0 thru 9 | goes to 14 |
| 14. | Line 1 | New Password | | |
| | Line 2 | Password | Arrows | Enter accepts |
| | | ***X ↑ ↓ *** | scroll X | 4th digit and |
| | | | 0 thru 9 | goes to 15 |
| 15. Display | Line 1 | Accept XXXX | | XXXX = |
| entered | | | | Password |
| Password | | | | digits |
| | Line 2 | ↑ = Yes | | ↑ go to 21 |
| | | ↓ = No | | ↓ return to 10 |
| 16. Name | Line 1 | Choose Action | | |
| Receptacles | Line 2 | Name | Arrows | Enter goes to |
| | | Receptacles | display | 17 |
| | | ↑ ↓ | other | |
| | | | Set-up | |
| | | | operations | |
| 17. Select | Line 1 | NAME RE- | | |
| Receptacle 1 | | CEPTACLE1 | | |
| (R1) Name | Line 2 | xxxxxx | Arrows | Enter accepts |
| | | | scroll thru | goes to 18 |
| | | | x's = TV, | |
| | | | VCR, | |
| | | | DVD, PC, | |
| | | | GAME, | |
| | | | AUX1, | |
| | | | AUX2, | |
| | | | OPEN | |
| 18. Name used | Line 1 | NAME USED | | Skip if no |
| for R2 | | FOR R2 | | duplication |
| | Line 2 | PRESS ANY | | Arrows or |
| | | KEY | | Enter goes to |
| | | | | 16 |
| 19. Select | Line 1 | NAME RE- | | |
| Receptacle 2 | | CEPTACLE2 | | |
| (R2) Name | Line 2 | xxxxx | Arrows | Enter accepts |
| | | | scroll thru | goes to 20 |
| | | | x's = TV, | |
| | | | VCR, | |
| | | | DVD, PC, | |
| | | | GAME, | |
| | | | AUX1, | |
| | | | AUX2, | |
| | | | OPEN | |
| 20. Name used | Line 1 | NAME USED | | Skip if no |
| for R1 | | FOR R1 | | duplication |
| | Line 2 | PRESS ANY | | Arrows or |
| | | KEY | | Enter goes to |
| | | | | 16 |
| 21. Exit Setup | Line 1 | Choose Action | | |
| or Operational | Line 2 | Exit ↑ ↓ | Arrows | Enter goes to 1 |
| Menus | | | display | (i.e., Normal |
| | | | other | display) |
| | | | Set-up | |
| | | | operations | |

TABLE 4
ALLOWANCE MENU

| DESCRIPTION | DISPLAY | | OPTIONS | COMMENTS |
|---|---|---|---|---|
| 22. Allowance | | Choose Action | | |
| Mode | | Select | Arrows | Enter goes to |
| Programming | | Receptacle ↑ ↓ | display | 23 |
| | | | other | |
| | | | Allowance | |
| | | | mode | |
| | | | operations | |
| 23. Select | Line 1 | RECEP- | | |
| Receptacle | | TACLE/EXIT | | |
| or exit | Line 2 | xxxx | Arrows | Enter sets |
| | | | scroll thru | receptacle or |
| | | | Recep- | goes to 21 if |
| | | | tacles (as | Exit displayed |
| | | | set in 17 | |
| | | | or 19) and | |
| | | | EXIT | |
| 24. Override | Line 1 | Choose Action | | |
| Program | Line 2 | Override ↑ ↓ | Arrows | Enter goes to |
| times | | | display | 25 |
| | | | other | |
| | | | Allowance | |
| | | | mode | |
| | | | operations | |
| 25. Override | Line 1 | OVERRIDE | | |
| Time | Line 2 | AAAAAAA | Arrows | Enter accepts |
| | | | scroll A's | and goes to 21 |
| | | | thru | |
| | | | Active, | |
| | | | Stay On, | |
| | | | Stay Off, | |
| | | | All Day, | |
| | | | All Week, | |
| | | | Restore, | |
| | | | and No | |
| | | | Change | |
| 26. | Line 1 | Choose Action | | |
| | Line 2 | Program Time | Arrows | Enter goes to |
| | | ↑ ↓ | display | 27 or 28 |
| | | | other | |
| | | | Allowance | |
| | | | mode | |
| | | | operations | |
| 27. Maximum | Line 1 | Entries are full | | Skiped if not |
| Program | | | | full |
| entries made | Line 2 | Press Any Key | | Arrows and |
| | | | | enter goes to |
| | | | | 21 |
| 28. | Line 1 | Program Time | | |
| | Line 2 | Day = | Arrows | Enter accepts |
| | | XXXXXX ↑ ↓ | scroll X's | and goes to X |
| | | | thru SUN- | |
| | | | THU, | |
| | | | MON- | |
| | | | FRI, | |
| | | | SAT- | |
| | | | SUN, | |
| | | | EVERY- | |
| | | | DAY, | |
| | | | SUN, | |
| | | | MON, | |
| | | | TUE, | |
| | | | WED, | |
| | | | THU, | |
| | | | FRI, | |
| | | | SAT | |
| 29. | Line 1 | Program Time | | |
| | Line 2 | Begin = | Arrows | ↑ go to 20 |
| | | XX:XXYY | scroll XX: | ↓ go to Next |
| | | ↑ ↓ | XXYY in | |
| | | | 30 minute | |
| | | | incre- | |
| | | | ments— | |
| | | | 12:00AM | |
| | | | thru | |
| | | | 11:30PM | |
| 30. | Line 1 | Program Time | | |
| | Line 2 | Length = | Arrows | Enter goes to |
| | | XX:XX | scroll | exit option X |
| | | | XX:XX in | |
| | | | 15 minute | |
| | | | incre- | |
| | | | ments— | |
| | | | 00:00 to | |
| | | | 99:45 | |
| 31. View Pro- | Line 1 | Choose Action | | |
| gramTimes | Line 2 | Show Times | Arrows | Enter goes to |
| | | ↑ ↓ | display | 32 |
| | | | other | |
| | | | Allowance | |
| | | | mode | |
| | | | operations | |
| 32. | Line 1 | EVERYDAY | | |
| | Line 2 | *10:30PM | Arrows | Enter is |
| | | 01:30 ↑ ↓ | scroll thru | ignored |
| | | *example | the list of | |
| | | display | times pro- | |
| | | | grammed | |
| | | | (i.e., | |
| | | | start time | |
| | | | and | |
| | | | length) | |
| | | | and goes | |
| | | | to X | |
| 33. | Line 1 | Show Times | | |
| | Line 2 | Enter = Exit | Arrows | Enter goes to |
| | | ↑ ↓ | scroll thru | 21 |
| | | | the list of | |
| | | | times pro- | |
| | | | grammed | |
| | | | (i.e., | |
| | | | start time | |
| | | | and | |
| | | | length) | |
| 34. Erase | Line 1 | Choose Action | | |
| Programmed | Line 2 | ERASE Time | Arrows | Enter goes to |
| Time | | ↑ ↓ | display | 35 |
| | | | other | |
| | | | Allowance | |
| | | | mode | |
| | | | operations | |
| 35. | Line 1 | EVERYDAY | | |
| | Line 2 | *10:30PM | Arrows | Enter goes to |
| | | 01:30 ↑ ↓ | scroll thru | 36 |
| | | *example | the list of | |
| | | display | times pro- | |
| | | | grammed | |
| | | | (i.e., start | |
| | | | time and | |
| | | | length) | |
| 36. | Line 1 | EVERYDAY | | |
| | | 10:30PM | | |
| | Line 2 | Erase ↑ = | ↑ erases | Enter is |
| | | Yes ↓ = No | time | ignored ↓ |
| | | | displayed | |
| | | | on Line 1 | |
| | | | and goes | |
| | | | to 21, ↓ | |
| | | | goes to 34 | |
| 37. | Line 1 | ERASE Time | | |
| | Line 2 | Enter = Exit | Arrows | Enter goes to |
| | | ↑ ↓ | scroll thru | 21 |
| | | | the list of | |
| | | | times pro- | |
| | | | grammed | |
| | | | (i.e., start | |
| | | | time and | |
| | | | length) | |

TABLE 5
TIMED ON MENU

| DESCRIPTION | DISPLAY | | OPTIONS | COMMENTS |
|---|---|---|---|---|
| 38. Select | Line 1 | RECEP- | | |
| Receptacle | | TACLE/EXIT | | |
| or Exit | Line 2 | xxxx | Arrows | Enter sets |
| | | | scroll thru | receptacle or |
| | | | Recep- | goes and to 21 |
| | | | tacles (as | if Exit |
| | | | set in 17 | displayed |
| | | | or 19) | |
| | | | EXIT | |
| 39. Time | Line 1 | Duration on | | |
| Duration | Line 2 | Lenght = | Arrows | Enter accepts |
| | | XX:XX | scroll thru | and goes to |
| | | | XX:XX in | Normal |
| | | | 15 minute | Operating |
| | | | increments | Mode |
| | | | 00:00 to | |
| | | | 99:45 | |

[image]

[image]

What is claimed is:

1. A device for controlling power to electrically powered equipment having a first power line for supplying power to the equipment, said device comprising:
one or more receptacles for engaging the first power line and selectively supplying power to the equipment;
a second power line for connection to an alternating current (AC) power source;
one or more switches, each switch for selectively interconnecting one of the receptacles to the second power line; and
a control circuit for controlling operation of each of the one or more switches, each switch being controlled by the control circuit to operate in a first mode or a second mode, wherein the first mode controls the switch so that the electrically powered equipment is permitted to be energized between specified times or is restricted from being energized between specified times, and wherein the second mode controls the switch so that the electrically powered equipment is permitted to be energized for a specified duration of time or is restricted from being energized for a specified duration of time.

2. The device of claim 1 wherein the first mode includes an allowance mode and a non-allowance mode, said allowance mode permitting the electrically powered equipment to be energized beginning at a specified time and ending at a specified time, and said non-allowance mode prohibiting the electrically powered equipment from be energized beginning at a specified time and ending at a specified time.

3. The device of claim 1 wherein the second mode includes a timed-on mode and a timed-off mode, wherein said timed-on mode permits the electrically powered equipment to be energized during a specified duration of time beginning when the mode is activated, and wherein said timed-off mode prohibits the electrically powered equipment from energizing during a duration of time beginning at end of the timed-on mode and ending at the beginning of a next timed on mode.

4. The device of claim 1 wherein each receptacle is independently controllable during either the first mode or the second mode.

5. The device of claim 1 further including one or more selectively locked compartments within which the one or more receptacles are located for engaging the first power line such that the first power line cannot be removed from the compartment when the compartment is locked.

6. The device of claim 1 wherein, if the operator selects the first mode, the operator may program the control circuit to prevent operation of the electrically powered equipment between a first specified time and a second specified time.

7. The device of claim 1 wherein, if the operator selects the second mode, the operator programs the control circuit to allow certain duration of time for operating the electrically powered equipment.

8. The device of claim 1 wherein, if the operator selects the first mode, the operator programs the control circuit to prohibit the equipment from energizing between specified times for a particular day or between specified times for multiple days of a week.

9. The device of claim 1 wherein the control circuit controls the power supplied to the receptacles by opening and closing power relays controlling the one or more switches which are in series between each receptacle and the second power line.

10. The device of claim 1 wherein the control circuit comprises a microcontroller and/or a logic controller.

11. The device of claim 10 wherein the microcontroller provides an output “inhibit” signal to the logic controller wherein, in the first mode, the inhibit signal is provided during periods when the equipment is not permitted to be energized and, in the second mode, the inhibit signal is provided after the allotted time period for operation of the equipment has expired.

12. The device of claim 1 wherein the device includes a keypad and a display, wherein the operator uses the key pad to interact with one or more menus displayed via a display to program the first and/or second modes operation of the device, and wherein the device is responsive to an authorization code (e.g., password) entered enter via the key pad to provide access to the one or more menus.

13. The device of claim 12 wherein the control circuit manages the keypad and display, and provides an output signal (i.e. the “inhibit” signal) to power relays controlling the one or more switches when a violation has occurred in either mode.

14. The device of claim 12 wherein the one or more menus include:
a setup menu for selecting whether the device operates in the first mode or the second mode;
an allowance menu for programming the specified times between which the electrically powered equipment is permitted to be energized when operating in allowance mode;
a timed-on menu for programming the specified duration of time during which the electrically powered equipment is permitted to be energized when operating in the timed-on mode; and
a sign on menu for entering an authorization code to access the setup, allowance and/or timed-on menus.

15. The device of claim 12 wherein a locked compartment comprises a setup menu switch for accessing the setup, allowance and/or timed-on menus without the authorization code, and/or for resetting the authorization code.

16. The device of claim 1 further comprising an override option for delaying the start of a restricted time period, as defined by the first mode, such that a currently active time period is extended by a predetermined time period (e.g., 15 minutes).

17. The device of claim 1 further comprising an override option for overriding a currently active time period, as defined by the second mode, and extending the period that equipment is energized by a predetermined time period (e.g., 15 minutes).

18. A device for controlling power to electrically powered equipment having a first power line for supplying power to the equipment, said device comprising:
an input device for entering computer executable instructions;
a memory for storing the entered executable instructions;
a clock for generating a clock signal one or more receptacles for engaging the first power line and selectively supplying power to the equipment;
a second power line for connection to an alternating current (AC) power source;
one or more switches, each switch for selectively interconnecting one of the receptacles to the second power line; and
a control circuit responsive to the input device, clock signal, and stored executable instructions for controlling operation of each of the one or more switches, each switch being controlled by the control circuit to operate in an allowance mode first mode or a second mode, wherein the first mode controls the switch so that the electrically powered equipment is permitted to be energized between specified times or is restricted from being energized between specified times, and wherein the second mode controls the switch so that the electrically powered equipment is permitted to be energized for a specified duration of time or is restricted from being energized for a specified duration of time.

19. The device of claim 18 wherein the device further includes a display, wherein the operator uses the key pad to interact with one or more menus displayed via a display to enter executable instructions for the first and/or second modes operation of the device, and wherein the device is responsive to an authorization code (e.g., password) entered enter via the key pad to provide access to the one or more menus.

20. The device of claim 19 wherein the one or more menus include:
a setup menu for selecting whether the device operates in the first mode or the second mode;
an allowance menu for programming the specified times between which the electrically powered equipment is permitted to be energized when operating in allowance mode;
a timed-on menu for programming the specified duration of time during which the electrically powered equipment is permitted to be energized when operating in the timed-on mode; and
a sign on menu for entering an authorization code to access the setup, allowance and/or timed-on menus.

21. The device of claim 18 wherein the first mode includes an allowance mode and a non-allowance mode, said allowance mode permitting the electrically powered equipment to be energized beginning at a specified time and ending at a specified time, and said non-allowance mode restricting the electrically powered equipment from be energized beginning at a specified time and ending at a specified time.

22. The device of claim 18 wherein the second mode includes a timed-on mode and a timed-off mode, wherein said timed-on mode permits the electrically powered equipment to be energized during a specified duration of time beginning when the mode is activated, and wherein said timed-off mode restricts the electrically powered equipment from energizing during a duration of time beginning at end of the timed-on mode and ending at the beginning of a next timed on mode.
